(19) United States
(12) Patent Application Publication
(10) Pub. No.: US 2006/0045947 A1
(43) Pub. Date: Mar. 2, 2006

(54) Method of adorning foodstuff

(76) Inventor: Lewis Churnick, Williston, FL (US)

Correspondence Address: Lewis Churnick;c/o Photo Frost, 21029 NE Hwy 27, Williston, FL, 32696, US

(21) Appl. No.: 11/019,997

(22) Filed: Dec. 23, 2004

Related U.S. Application Data
(60) Provisional application No. 60/606,108, filed on Sep. 1, 2004.

(51) Int. Cl. A23G 3/28

(52) U.S. Cl. 426/383

(57) ABSTRACT

A method of decorating the surface of foodstuffs with photos or images using edible media including the steps of preparing a silk screen with predetermined shapes. The predetermined patterns having opening therein that are in a size and shape that is dictated by the size and shape of the foodstuffs. The thus prepared silk screen is placed in a silk screen apparatus. A substrate or backing is prepared having a coating that is approved for receiving foodstuff thereon. The substrate is placed under the prepared silk screen in a frame. A batter is laid over the silk screen by a flexible blade. A second flexible blade is used that will push the batter through the openings in the silk screen and deposit the batter according to the predetermined pattern in the screen. The batter patterns on the backing are air cured to a semi-dry, flexible state. These are now edible media upon which can be imprinted images by stamping, drawing, screen printing or passing through an inkjet printer or copier. The edible media with image is then removed from the substrate and applied to the foodstuff having the same dimensions and shape as the foodstuff without any further manipulations such as sizing and cutting.

### CROSS REFERENCE TO RELATED APPLICATIONS

This application is a Continuation of a previously filed Provisional Application having Ser. No. 60/606,108. Filed on May 26, 2004.

### STATEMENT REGARDING FED SPONSORED R & D

(none)

### BACKGROUND OF THE INVENTION

The inventive method involves the creation of decorative edible items from selected images. The images are unique or personalized pictorial, graphic images or text emblems of an edible nature. The graphic images are produced economically, efficiently and cost effectively, with minimal skill requirements on part of the user by means of printing on an edible media created in such a manner that it can have imagery applied in a variety of methods including, but not limited to stamped impressions logos, hand-drawn images, ink jet printing, or photocopier printing. The edible items or media can be made in a variety of pre-formed shapes or sizes thus eliminating the need for cutting either before or after the adornment is applied. Said edible media may then be applied in full contact to foodstuffs having a glaze coating, chocolate layer, whipped dairy or non-dairy topping, candy coating or a variety of other viscous coatings in order to affect a merge or bonding of the image-printed edible media to the foodstuff.

### DISCUSSION OF THE PRIOR ART (AMENDED)

MacPherson (U.S. Pat. No. 5,017,394)
1) MacPherson prescribes “a [screen] mesh size from 40 (strands per inch) . . . to a mesh size of 16 (strands per inch)” {Page 8} Such screen printing to create the edible media creates a rough texture, detracting from image resolution when printing photographs. Thus it shall be necessary to locate or develop a special screening material in order to attain a finish adequately smooth for photo reproduction.
2) The batter or “edible, fluid material” as it is called must be reformulated to attain a flowable state suitable for the special screening material and to attain and maintain the required smooth quality surface finish.
3) In McPherson's method it is not mentioned that the final edible base shape is produced in two layers on the supportive backing. This creates a Base Shape of a thicker nature which results in a greater possibility of interfering or jamming the paper feed mechanism of certain printers and also a slower and less complete interaction between the finished decoration and the dessert topping, thus making the existence of the base shape evident as a separate layer. We find this performance undesirable. It is our intent to produce the edible film in a single layer thus better controlling the thickness desired and also improving the efficiency of production.
4) Claim 5 {Page 4} states that “the edible base shape [must be] softenable by a temperature above room temperature” it is our objective for the interaction of the final decoration with a topping not require heat input. Therefore the batter or “edible, fluid material” must also be reformulated so as to react completely without the requirement of an environment above room temperature.
5) The requirement of a “peeling machine” {Page 6} to expedite the release of the edible decoration from the backing or carrier must be eliminated.
6) Although the possibility is mentioned of other common printing methods being utilized, screen printing is clearly the method for which MacPherson intends. This exemplified by the formula for edible ink as described on page 9, clearly for use in screen printing and not suitable for photographic reproduction by other printing means.
7) Although “multiple base shapes” is mentioned during creation it is evident that the intent indicates single base shapes on many pages for efficient production. In all other citings the base shape is indicated as singular on each supportive backing. It is intended to produce multiple base shapes specifically sized, shaped and located on a single backing in order to accommodate new applications.
8) MacPherson's result, named “edible images” by description and by historical record is clearly intended to be a mass-produced finished decoration of generic or licensed cartoon images. The method is not intended nor is it suitable for custom photographic reproduction efficiently or profitably.
9) In MacPherson's Description of Preferred Embodiments a formula for edible ink is set forth including “Water, Titanium Dioxide, Sorbistat K, Corn Starch, Maltodextrin, Cake Flour. By the very nature of this ingredients list it is clear that this formulation is not compatible with any known inkjet printing machine capable of photographic reproduction thereby precluding the product from this use.

Stuart (International Patent WO 95/01735)

Throughout this document it is stated that “the edible film is peelably released” yet in the summary states “the film itself [to be] very delicate and gossamer”. We find in practice these statements to be in conflict due to the delicate nature of the film and the act of peeling to frequently result in the tearing or damaging of the finished decoration prior to application on the dessert. Thusly two improvements are intended; first an improvement in the formula or recipe of the batter used in the making of the edible film so as to be more resilient to handling yet adequately responsive to the merge or reactive action with the topping or moisture contacted on application with the dessert item and also a modification of technique for removal of the film from the supportive backing to be less stressful to the edible film itself.

It is also stated that it may be “pre-printed with edible inks or may be hand-drawn upon by the user”. It is intended to simplify the process so as to allow the user ease in printing thus no longer requiring pre-printing by a professional or trained person.

Additionally it is stated that the edible film may be die cut or hand cut into selected shapes. It is intended to pre-cast custom shapes and multiple shapes per page for several purposes;
1) To eliminate costly die cutting or tedious hand cutting as an extra step in the process. This affords opportunity for efficient large-quantity commercial production utilizing repeated image reproduction on the same page for increased throughput and product uses in new applications such as (but not limited to) cookies or chocolates at reduced cost.
2) To afford the home user greater ease in specialty applications such as (but not limited to) cookies, cupcakes or chocolates.

Stuart indicates that the edible film in its initial state is translucent and can be altered using food dyes to be opaque colors. We find it necessary to alter the composition so that the natural state is opaque bright white in order to better carry a reproduced photographic image and also to avoid the showing through of other colors under the finished decoration such as dark chocolate.

Stuart states the “drying [of the edible film] may take 12 to 14 hours”. This lengthy step is impractical for efficient production in any facility of limited space. Our method will employ a drying apparatus to effectively reduce this step to approximately 2 hours or less.

The Food Packaging (Japan) article deals with Pullulan film, an unrelated edible film used for packaging. Chiltons Food Engineering reports again on Pullulan Films, pointing out that the film requires heat or steam to apply and dissolve. Also the Pullulan Film is transparent. This may be suitable for animal cartoons as stated but will not be capable of carrying high-resolution photographic images.

Rocky Mountain News reports of Tague Technologies using wafer paper, a substrate well known and dramatically inferior to “Icing Sheets”, the name chosen for our resultant product. Wafer paper has no supportive backing and has limited or nonexistent capability for blending with dessert toppings. Wafer paper cannot be described as ‘delicate’ nor does it possess similar performance properties.

Bell et al makes use of a sugar paste for edible ink (not fluid for inkjet) and rice paper, another well known substrate similar to wafer paper. It specifies printing images of foodstuffs by way of screen printing the ink paste. Inkjet printing will not be possible in this case. Also the layer of cornflower required between printed sheets is unnecessary with our method because they have a greater absorption factor. There is little similarity with this product.

Poughon's edible film is made from “communion waffle paste, almond paste, chocolate, gelatin” or ““almond paste, white chocolate, frosted sugar”. The support films are “plastic & edible matters, suffered paper, paraffin paper”. His edible ink and ink-jetting method are stated as not part of the invention.

What I claim is:

1. A method of applying an edible ink imagery to foodstuffs comprising the steps of preparing a silk screen with predetermined decorations openings therein with regard to number, size and shape having opening therein, said number, size and shape being predetermined by the size and shape of the foodstuff being decorated, placing said silk screen in a silk screening apparatus, coating a substrate backing with an approved for food coating, placing said substrate in a frame in position below said silk screen on a vacuum table spreading a batter on said silk screen with a first flexible blade and then pressing said batter through said openings in said silk screen onto said substrate with a second flexible blade to create an edible media, thereafter removing said substrate from said silk screening apparatus and drying said edible media to eliminate any tackiness but still remain flexible thereafter applying said imagery to said edible media at a different time and location to present decorations thereon.

2. (canceled)

3. The method of claim 1, including the wherein said application of said images is of a photographic nature by means of inkjet copier upon said edible media.

4. The method of claim 1, wherein said including the application of said images is of a photographic nature by means of a scanner to printing apparatus upon said edible media.

5. The method of claim 1, including the wherein said application is of hand-drawn images upon said edible media.

6. The method of claim 1, wherein said application is of stamped images upon said edible media.

7. The method of claim 1, wherein said application is of screen-printed images upon said edible media.

8. The method of claim 1, wherein said step of removing includes the step of removing said edible media with image applied from said support substrate.

9. The method of claim 1, wherein said step of removing includes the step of freezing.

10. The method of claim 1, wherein said step of removing included the step of heating.

11. The method of claim 1 including the step of applying said removed edible media with said decorations thereon to foodstuffs.

12. The method of claim 1, wherein said edible media with said decorations thereon is applied in full contact to foodstuff selected from the group consisting of cookies with a glaze coating, chocolate layer, whipped dairy or non-dairy topping, candy coating, egg-based or mirengue topping, cream cheese topping, piping gel coating, fondant or marzipan, said selected foodstuff having a coating thereon.

13. The method of claim 12 including the step of maintaining said coating in a molten viscous state.

14. The method of claim 13, wherein moisture in said coating is being absorbed into said edible media to affect a melt or merging action.

15. The method of claim 11 including the step of air-drying said edible media.

16. The method of claim 11 including the step of applying a mist spray of water to a surface of said dry foodstuff prior to placing said edible media thereon.

17. The method of claim 11 including the step of heating a top surface of said foodstuff until molten prior to placing said edible media order thereon.

18. The method of claims 16 including the step of allowing the applied decoration to air dry to complete a bonding process.

19. The method of claim 17 including the step of allowing the applied decoration to air dry to complete a bonding process.
